(19) United States
(12) Patent Application Publication
(10) Pub. No.: US 2007/0112105 A1
(43) Pub. Date: May 17, 2007

(54) Substituted thiophenylidene alditol derivatives and compositions

(76) Inventors: Chiu-Peng Tsou, Miao-Li Hsien (TW); Shun-Yuan Luo, Miao-Li Hsien (TW); Wen-Chen Wei, Miao-Li Hsien (TW); Cheng-Kuang Chan, Miao-Li Hsien (TW)

Correspondence Address: HERSHKOVITZ & ASSOCIATES, 2845 DUKE STREET, ALEXANDRIA, VA, 22314, US

(21) Appl. No.: 11/274,128

(22) Filed: Nov. 16, 2005

(51) Int. Cl. C08K 5/15

(52) U.S. Cl. 524/109; 524/543

(57) ABSTRACT

A compound of the formula: (I): 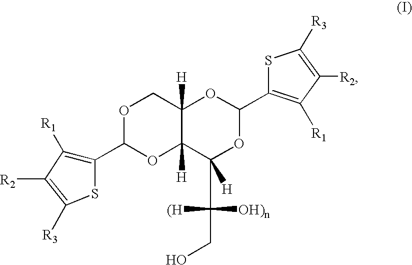
wherein R₁, R₂ and R₃ are independently selected from the group consisting of H, C₁-C₈ alkyl, (CH₂)ₙ-aryl (wherein n is 0-6, phenyl or benzyl), NO₂ or CN, F, Cl, Br and I; and n is 0 or 1. The present invention also relates to a compound of the formula (II): 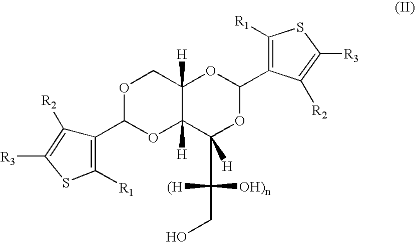
wherein R₁, R₂ and R₃ are independently selected from the group consisting of H, C₁-C₈ alkyl, (CH₂)ₙ-aryl (wherein n is 0-6, phenyl or benzyl), NO₂ or CN, F, Cl, Br and I; and n is 0 or 1.

### BACKGROUND OF THE INVENTION

1. Field of the Invention

This invention relates to new plastic additives, which are useful as nucleators and clarifiers for crystalline and semi-crystalline polyolefin compositions. More particularly, this invention discloses certain 1,3:2,4-di(substituted thenylidene)-D-alditol and polymer compositions thereof.

2. Description of the Related Art

The addition of nucleating agents to certain polymeric materials, such as polyolefins, is known to reduce the number of product molding cycles during the melting processing of semi-crystalline polymers, affect their physical properties and increase the clarity of these materials. When nucleating agents are used to improve the optical properties of semi-crystalline polymers (e.g., to increase clarity/transmittance), they are called clarifying agents.

Dibenzylidene sorbitol (DBS) has been proposed as an additive (Japanese Patent Application No. 94424/1974) to improve transparency, but this additive had reported compatibility limitations with polyolefin resins. U.S. Pat. No. 4,016,118 (1977) to Hamda et al. teaches that a polyolefin plastic composition containing 0.1% to 0.7% DBS as an additive will show improved transparency and reduced molding shrinkage over compositions containing a substituted benzoic acid salt.

Additional advancements in sorbitol-based clarification technology have been driven by the need for improved transparency, reduction of plate-out during processing, and improved organoleptic properties (e.g., odor, taste, etc.). To overcome these deficiencies, many derivatives of DBS in which the aromatic rings are substituted with various groups have been proposed. There are now several effective clarifying agents known to the industry, and available commercially at this time is also a type of nucleator, namely dibenzylidene sorbitol acetal derivative compounds (hereinafter collectively referred to as “DBS”). Compounds are mentioned as follow, such as 1,3:2,4-di(benzylidene)-D-sorbitol (EC-1, Gel All D, Irgaclear D, Millad 3905, NC-5); 1,3:2,4-di(4-tolylidene)-D-sorbitol (Gel All MD, Irgaclear DM, Millad 3940, NC-6); 1,3:2,4-di(3,4-dimethyl-benzylidene)-D-sorbitol (EC-1, Gel All D, Irgaclear D, Millad 3988); 1,3:2,4-di(4-ethyl-benzylidene)-D-sorbitol (EC-1, Gel All D, Irgaclear D, NC-4).

Apparent structural variations lead to differ results in light of literature reference; no underlying theory is available which allows for predictability of performance of an individual compound. In order to overcome these deficiencies, a “Heteroarylidene sobitol system” has been proposed.

Tanabe, in Japanese Patent Application No. 02233737/1990, discloses polyolefin plastic composition containing di(substituted fulfurylidene)-D-sorbitol (hereinafter collectively referred to as “DFS”) having the general formula: 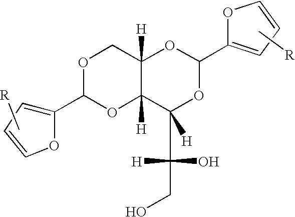
wherein R is selected from the group consisting of H and C₁-C₃ alkyl. A 1-mm sheet of polypropylene containing 0.3 phr DFS (R═H) had haze 58% and no odor, vs. 83% and no odor without DFS.

Syed, U.S. Pat. No. 5,574,174 discloses asymmetric 1,3-di(substituted arylidene)-2,4-(substituted thenylidene)-D-sorbitol having the general formula: 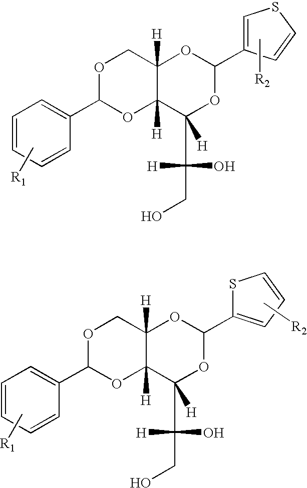
wherein R₁ is mono-, di-, or tri-substituted on the ring and represents a member selected from the class consisting of alkyl or O-alkyl groups having 1 to 8 carbon atoms, NO₂, CN and COOY, wherein Y is an alkyl group having 1 to 8 carbon atoms; wherein R₂ represents a member selected from the class consisting of H, C₁-C₆ alkyl, NO₂, Cl, Br and F. In a specific embodiment of U.S. Pat. No. 5,574,174, reaction of D-sorbitol with 2-thiophenecarboxaldehyde and condensation of the resulting 2,4-(2-thenylidene)-D-sorbitol with p-tolualdehyde gave a 3:1 mixture of 1,3-(4-tolylidene)-2,4-(2-thenylidene)-D-sorbitol and 1,3:2,4-di(4-tolylidene)-D-sorbitol, which (0.25%) was used for clarifying a propylene random copolymer showing haze 12.5% (40 mils sheet).

Thus, there still exists a need to have an excellent clarify agent.

### SUMMARY OF THE INVENTION

The present invention provides new and useful heteroarylidene aditol derivatives, which have the ability to function as clarifiers and nucleators in polyolefin plastic compositions.

An objective of this invention is to provide a new and useful plastic additive that can simultaneously induce high levels of nucleation efficiency as well as low degrees of haze (and thus excellent clarity) of polyolefins without deteriorating the mechanical and chemical properties of the final products.

Another objective of this invention is to provide a polyolefin plastic composition having improved transparency as a result of incorporating a specific additive.

The above objectives of this invention can be achieved by a polyolefin plastic composition having improved transparency, which comprises at least one di(substituted thenylidene)-aditol derivative.

The substituted thenylidene aditol derivatives are 1,3:2,4-di (substituted thenylidene)-D-sorbitol system (hereinafter collectively referred to as “DTS”) and 1,3:2,4-di(substituted thenylidene)-D-xlyitol system (hereinafter collectively referred to as “DTX”), having the structure formula (I) or (II): 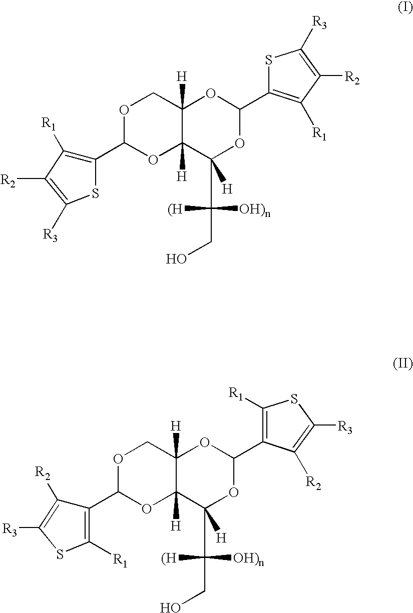
wherein R₁, R₂, R₃ are independently selected from the group consisting of H, C₁-C₈ alkyl, (CH₂)ₙ-aryl (wherein n is 0-6, phenyl or benzyl), NO₂ or CN, F, Cl, Br and I; and n is 0 or 1. Quite surprisingly, 1,3:2,4-di(5-substituted thenylidene)-D-sorbitol according to the present invention is excellent as nucleating and clarifying additives for polyolefin plastic compositions.

The polyolefin plastic compositions based on crystalline and semi-crystalline polyolefin polymers or polyolefin resin compositions consisting essentially of at least one homopolymer of an aliphatic monoolefin or a copolymer of a C₂-C₈ alpha-monoolefin, particularly propylene polymer material and mixtures of such polyolefin polymers (e.g., polyproproylene). Well-known commercial crystalline polypropylene products are normally solid, predominantly isotactic, semi-crystalline, thermoplastic homopolymer formed by the polymerization of propylene. As used herein, semi-crystalline means a crystallinity of at least about 5-10% as measured by X-ray diffraction. Also, the typical average molecular weight (Mw) of the normally solid commercial polypropylene is 100,000-4,000,000. Moreover, the melting point of the normally solid commercial polypropylene is from about 159°-169° C.

As used herein, the general term “propylene polymer material” means: (I) isotactic or syndiotactic polypropylene and blends thereof, (II) crystalline and semi-crystalline random copolymers and terpolymers comprising a majority of propylene and at least one comonomer selected from the group consisting of ethylene and C₄ to C₈ alpha-monoolefin, and mixtures of said copolymers and terpolymers with themselves and one another. Other useful polyolefins include linear low-density polyethylene (LLDPE), low-density polyethylene (LDPE), medium-density polyethylene(MDPE), high-density polyethylene (HDPE), polymethylpentene and mixtures of at least two of these, including the propylene polymers described above. Preferred polyolefin resins are the propylene homopolymer, propylene/ethylene copolymer, linear low-density polyethylene and low-density polyethylene. Propylene polymers having a significant proportion by weight of propylene units are especially preferred.

The 1,3:2,4-di(substituted thenylidene)-D-sorbitol system (hereinafter collectively referred to as “DTS”) and 1,3:2,4-di(substituted thenylidene)-D-xylitol system (hereinafter collectively referred to as “DTX”) of the present invention, which are prepared by the condensation reaction of one mole of D-sorbitol or D-xylitol with about 2 moles of one certain substituted thiophenecarboxaldehyde, having structure (III) or (IV), in the presence of an acid catalyst, 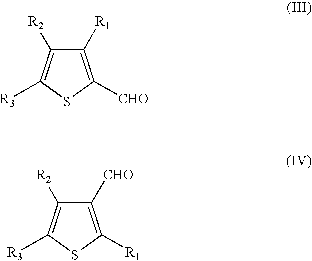
wherein R₁, R₂ and R₃ are independently selected from the group consisting of H, C₁-C₈ alkyl, (CH₂)ₙ-aryl (wherein n is 0-6, phenyl or benzyl), NO₂ or CN, F, Cl, Br and I; and n is 0 or 1. For example, 3-thiophenecarboxaldehyde, 2-thiophenecarboxaldehyde, 3-methyl-2-thiophenecarboxaldehyde, 5-methyl-3-thiophenecarboxaldehyde, 5-methyl-2-thiophenecarboxaldehyde, 5-ethyl-3-thiophenecarboxaldehyde, 5-ethyl-2-thiophenecarboxaldehyde, 5-tert-butyl-3-thiophenecarboxaldehyde, 5-tert-butyl-2-thiophenecarboxaldehyde, 5-phenyl-3-thiophenecarboxaldehyde, 5-phenyl-2-thiophenecarboxaldehyde, 5-nitro-3-thiophenecarboxaldehyde, 5-nitro-2-thiophenecarboxaldehyde, 5-chloro-3-thiophenecarboxaldehyde, 5-chloro-2-thiophenecarboxaldehyde, 5-bromo-3-thiophenecarboxaldehyde, 5-bromo-2-thiophenecarboxaldehyde, and the like.

The acid catalyst used in the reaction is preferably selected from sulfuric acid, phosphoric acid, hydrochloric acid, methanesulfonic acid, champhorsulfonic acid, p-toluenesulfonic acid, naphthalenesulfonic acid, and the like. The reaction medium used in the reaction is selected from methanol, ethanol, DMF, acetonitrile, and aromatic solvent containing methanol or trimethylorthoformate. The condensation reaction can be carried out at various temperatures. In the case of 3-thiophenecarboxaldehyde, for instance, it has been determined that such reaction may be desirably carried out at ambient or room temperatures.

The amount of the DTSs and DTXs to be incorporated in the polyolefin composition of this invention is from about 0.005 to about 2% by weight, preferably from about 0.05 to 0.5% by weight, especially preferably from about 0.1 to 0.3% by weight, based on the weight of the composition.

The additives of the present invention may be added alone or with other conventional clarifiers to improve the clarity of polyolefin products. Furthermore, the additives cannot only be added to monomer polyolefin products, but can also be added to polymer polyolefin products. Furthermore, the polyolefin products with the additive of the present invention, may also further comprise dyes to improve appearance or other conventional components to improve physical characteristics.

The compositions of the present invention are suitable as additives to improve the clarity of packaging materials and container materials for cosmetics, food-stuffs, and the like, because they give film, sheet, and other fabricated articles excellent transparency and physical properties.

### DETAILED DESCRIPTION OF THE INVENTION

The following process for preparing a compound of formula (I) and (II), having a heteroarylidene compound of the general formula:

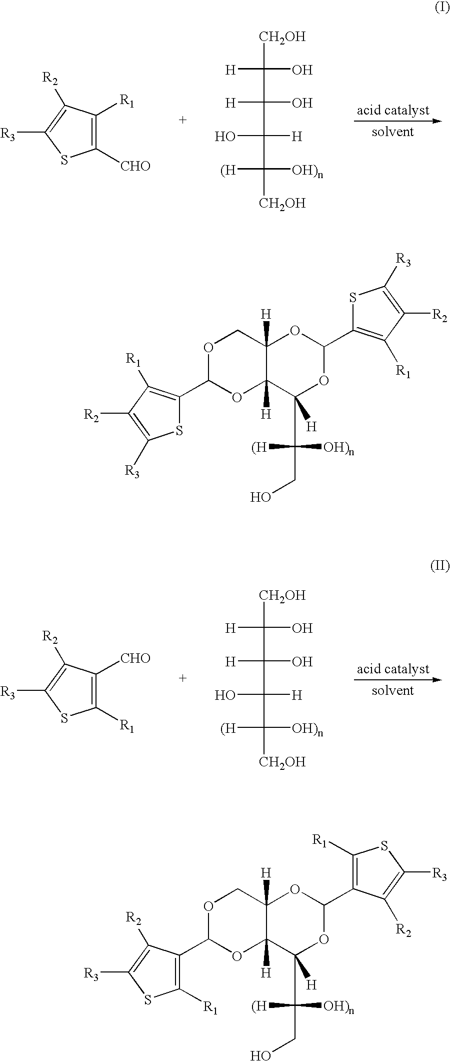

wherein R₁, R₂ and R₃ are independently selected from the group consisting of H, C₁-C₈ alkyl, (CH₂)ₙ-aryl (wherein n is 0-6, phenyl or benzyl), NO₂ or CN, F, Cl, Br and I; and n is 0 or 1; and reacting with sorbitol (n=1) or xylitol (n=0) in the presence of an acid catalyst.

The term “article” as used herein refers to crystalline or semi-crystalline polyolefin products containing the additives disclosing in the present invention, as merely examples, food or cosmetic containers or packaging.

The following examples further illustrate the present invention but are not to be construed as limiting the invention as defined in the claims appended hereto. All parts and percents given in these examples are by weight unless otherwise indicated.

### EXAMPLE 1

### Preparation of 1,3:2,4-di(3-thenylidene)-D-xylitol

A 250-ml four-necked cylindrical shaped reaction flask equipped with a thermometer, nitrogen inlet, and a mechanical stirrer was charged with D-xylitol (10.00 g, 0.066 mole), methanol (100 ml), champhorsulfonic acid (0.50 g, 2.2 mmole), and 3-thiophenecarboxaldehyde (14.80 g, 0.1320 mole). The reaction mixture was stirred at room temperature for 48 hours, neutralized with a solution of 4% NaOH aqueous. The white solid was collected by filtration, and dried in a vacuum oven to give 1,3:2,4-di(3-thenylidene)-D-xylitol as a fine white powder (15.95 g, yield 71%), melting point 209.5˜210.4° C.; ¹H NMR (500 MHz, d₆-DMSO) δ 7.53˜7.49 (m, 4H), 7.13˜7.08 (m, 2H), 5.73 (s, 1H), 5.66 (s, 1H), 4.87˜4.70 (bs, 1H), 4.13˜4.07 (dd, 2H, J=12.6, 8.5 Hz), 4.08 (s, 1H), 4.07˜3.94 (m, 1H), 3.88 (d, 1H, J=1.2 Hz).

### EXAMPLE 2

### Preparation of 1,3:2,4-di(3-thenylidene)-D-sorbitol

A 1000-ml four-necked cylindrical shaped reaction flask equipped with a thermometer, nitrogen inlet, and a mechanical stirrer was charged with D-sorbitol (20.00 g, 0.1098 mole), methanol (200 ml), methanesulfonic acid (1.00 g, 10.4 mmole), and 3-thiophenecarboxaldehyde (25.00 g, 0.2229 mole). The reaction mixture was stirred at room temperature for 48 hours, neutralized with a solution of 4% NaOH aqueous. The white solid was collected by filtration, washed with 40% methanol aqueous and dried in a vacuum oven to give 1,3:2,4-di(3-thenylidene)-D-sorbitol as a fine white powder (29.25 g, yield 72.0%), melting point 237.0˜239.8° C.; ¹H NMR (500 MHz, d6-DMSO) δ 7.49˜7.48 (m, 4H), 7.13˜7.08 (m, 2H), 5.68 (s, 2H), 4.81 (d, 1H, J=7.0 Hz), 4.38 (m, 1H), 4.13˜4.09 (m, 3H), 3.89 (s, 1H), 3.81˜3.71 (m, 2H), 3.63˜3.57 (m, 1H), 3.48˜3.39(m, 1H).

### EXAMPLE 3

### Preparation of 1,3:2,4-di(5-methyl-2-thenylidene)-D-sorbitol

A 1000 ml four-necked cylindrical shaped reaction flask equipped with a thermometer, nitrogen inlet, and a mechanical stirrer was charged with D-sorbitol (20.00 g, 0.1098 mole), methanol (200 ml), methanesulfonic acid (1.00 g, 10.4 mmole), and 5-methyl-2-thiophenecarboxaldehyde (25.00 g, 0.1982 mole). The reaction mixture was stirred at room temperature for 48 hours, neutralized with a solution of 4% NaOH aqueous. The white solid was collected by filtration, washed with 40% methanol aqueous and dried in a vacuum oven to give 1,3:2,4-di(5-methyl-2-thenylidene)-D-sorbitol as a fine white powder (27.29 g, yield 69.2%), melting point 209.5˜210.4° C.; ¹H NMR (500 MHz, d6-DMSO) δ 6.90˜6.87 (m, 2H), 6.68˜6.67 (m, 2H), 5.78 (s, 2H), 4.73 (d, 1H, J=5.8 Hz), 4.35 (t, 1H, J=5.8 Hz), 4.11 (dd, 1H, J=12.6, 1.8 Hz), 4.06˜4.02 (s+dd, 2H), 3.87 (d, 1H, J=1.3 Hz), 3.77 (dd, 1H, J=7.3, 1.6 Hz), 3.70˜3.67 (m, 1H), 3.62˜3.54 (m, 1H), 3.40˜3.34 (m, 1H), 2.41 (s, 6H).

### EXAMPLE 4

### Polyolefin Formation and Testing

It is well known in the art to add a clarifier to polyolefin products. Therefore, in the present invention only shows the components of the target polypropylene product, and the procedure to prepare the target polypropylene products.

Two-kilogram batches of the target polypropylene were produced in accordance with the following table 1.

TABLE 1
Components of the Target Polypropylene

| Components | Weight (g) |
|---|---|
| Polypropylene (ST868) | 2000 g |
| Irgnox1010, Primary Antioxidant | 2.00 g |
| Irganox168, Secondary Antioxidant | 1.80 g |
| Calcium Stearate, Acid Scavenger | 1.40 g |
| Inventive Diacetal from Example 2 | 4.00 g |

The basic resin and all additives were weighed and then blended. All samples were then melt compounded on an injector at a ramped temperature from about 180° C. to 220° C. through three heating zones. The melt temperature upon exit of the injector die was about 215° C. The screw had a length/diameter ratio of 24. Plaques of the desired polypropylene were then made through injection into the injection molder. The molder barrel was set at a temperature anywhere between 190 and 260° C., with a range of from about 200 and 240° C. preferred. The plaques had a dimension of 142×108×2.54 mm³, and were made in a mold having a mirror finish. The mold cooling air was controlled at a temperature of about 23° C.

The haze values were measured by ASTM Standard Test Method D1003-61 “Standard Test Method for Haze and Luminous Transmittance of Transparent Plastics” using BYK Gardner XL-211 Hazemeter. Nucleation capabilities were measured as polymer re-crystallization temperatures (which indicate the rate of polymer formation provided by the presence of the nucleating additive) by melting the target plaques, cooling the plaques at a rate of about 10° C./minute, and recording the temperature at which polymer reformation occurs. Control plaques were without alditol additives.

TABLE 2
Result of polypropylene plaques adding inventive
diacetal from the above Examples.

| Test | Inventive | Conc. | | Tc (DSC) | Part Think. |
|---|---|---|---|---|---|
| Plaque No. | diacetal from | (%) | Haze | ° C. | (mil) |
| 1 | None | — | 78.7 | 101.8 | 100 |
| 2 | Example 2 | 0.20 | 61.4 | 113.2 | 100 |
| 3 | Example 3 | 0.20 | 31.3 | 119.4 | 100 |
| 4 | Example 3 | 0.25 | 24.6 | 119.9 | 100 |

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A compound of the formula (I), 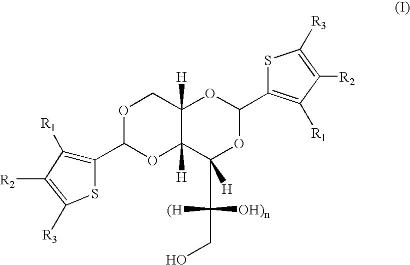
wherein R₁, R₂ and R₃ are independently selected from the group consisting of H, C₁-C₈ alkyl, (CH₂)ₙ-aryl (wherein n is 0-6, phenyl or benzyl), NO₂ or CN, F, Cl, Br and I; and n is 0 or 1.

2. The compound of claim 1, which is di-acetal is 1,3:2,4-di(5-methyl-2-thenylidene)-D-sorbitol.

3. A nucleator for the polymerization of the polyolefins comprising any of the compound as claimed in claim 1.

4. The nucleator as claimed in claim 3, which is 1,3:2,4-di(5-methyl-2-thenylidene)-D-sorbitol.

5. A polyolefin composition characterized in that at least a nucleator as claimed in claim 3 is added during the polymerization of the polyolefin.

6. The polyolefin composition as claimed in claim 5 characterized in that at least a nucleator that is 1,3:2,4-di(5-methyl-2-thenylidene)-D-sorbitol is added during the polymerization of the polyolefin.

7. The polyolefin composition as claimed in claim 6, characterized in that 1,3:2,4-di(5-methyl-2-thenylidene)-D-sorbitol is added during the polymerization of the polyolefin.

8. A transparent polyolefin plastic article comprising the polyolefin composition as claimed in claim 5.

9. The transparent polyolefin plastic article as claimed in claim 8, characterized by comprising the polyolefin composition containing at least a nucleator that is 1,3:2,4-di(5-methyl-2-thenylidene)-D-sorbitol.

10. The transparent polyolefin plastic article as claimed in claim 9, characterized by comprising the polyolefin composition containing a nucleator that is 1,3:2,4-di(5-methyl-2-thenylidene)-D-sorbitol.

11. A compound of the formula (II) 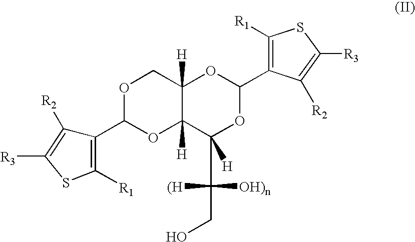
wherein R₁, R₂ and R₃ are independently selected from the group consisting of H, C₁-C₈ alkyl, (CH₂)ₙ-aryl (wherein n is 0-6, phenyl or benzyl), NO₂ or CN, F, Cl, Br and I; and n is 0 or 1.

12. The compound of claim 11, which is di-acetal is 1,3:2,4-di(3-thenylidene)-D-sorbitol.

13. A nucleator for the polymerization of the polyolefins comprising any of the compound as claimed in claim 11.

14. The nucleator as claimed in claim 13, which is 1,3:2,4-di(3-thenylidene)-D-sorbitol.

15. A polyolefin composition characterized in that at least a nucleator as claimed in claim 13 is added during the polymerization of the polyolefin.

16. The polyolefin composition as claimed in claim 15 characterized in at least a nucleator that is 1,3:2,4-di(3-thenylidene)-D-sorbitol is added during the polymerization of the polyolefin.

17. The polyolefin composition as claimed in claim 16, characterized is that 1,3:2,4-di(3-thenylidene)-D-sorbitol during the polymerization of the polyolefin.

18. A transparent polyolefin plastic article comprising the polyolefin composition as claimed in claim 15.

19. The transparent plastic polyolefin article as claimed in claim 18, characterized by comprising the polyolefin composition containing at least a nucleator that is 1,3:2,4-di(3-thenylidene)-D-sorbitol.

20. The transparent plastic polyolefin article as claimed in claim 19, characterized by comprising the polyolefin composition containing a nucleator that is 1,3:2,4-di(3-thenylidene)-D-sorbitol.
